(19) United States
(12) Patent Application Publication
(10) Pub. No.: US 2003/0210335 A1
(43) Pub. Date: Nov. 13, 2003

(54) System and method for editing images on a digital still camera

(76) Inventors: Frank Paul Carau SR., Loveland, CO (US); Dan Leany Dalton, Greely, CO (US)

Correspondence Address: Hewlett-Packard Company, Intellectual Property Administration, P.O. Box 272400, Fort Collins, CO, 80527-2400, US

(21) Appl. No.: 10/140,321

(22) Filed: May 7, 2002

(51) Int. Cl. H04N 5/76

(52) U.S. Cl. 348/231.2

(57) ABSTRACT

A system for editing images on a digital camera is disclosed. An exemplary system comprises an image capture element for capturing an original image, a memory for temporarily storing the original captured image as an image file, a first logic for generating edit description information used to edit the original captured image and for creating an edited image, where the edited image replaces the original captured image in the memory, and a second logic for generating undo edit description information used to reverse the edits and restore the original captured image. Exemplary methods and computer readable media are also disclosed.

### BACKGROUND OF THE INVENTION

1. Field of the Invention

The invention relates generally to electronic image capture, and, more particularly, to a system and method for editing images on a digital still camera.

2. Related Art

Digital photography is becoming more and more popular due to the availability of affordable digital cameras. As these digital cameras continue to be developed, new features continually become available. Due to advances in processing power and memory design, the storage capacity of digital cameras continues to increase, thus continually making available new and advanced features. For example, a desirable feature in digital still cameras is the ability to immediately review a captured image on a display built into the digital camera. With the processing power and memory capacity available in today's digital still cameras, basic operations, such as rotation and deletion of the captured image, can be performed directly on the camera.

However, due to memory and processing power limitations, some desirable features remain beyond the capability of today's digital cameras. For example, on-camera editing of a captured image requires significant memory capacity because both the original image and the edited version of the image must be stored in a memory. Such editing is typically performed by transferring a file containing the captured image to an external computer, such as a personal computer (PC), and using the PC to perform the desired editing and file storage. Unfortunately, this eliminates the possibility of immediately editing the captured image and requires that many image files be stored on the digital camera until they can be transferred to an external processing device for editing.

Therefore, it would be desirable to have an efficient and convenient way to perform on-camera editing of a captured image, while minimizing the number and size of files that are stored on the camera.

### SUMMARY

An embodiment of the invention includes a system for editing images on a digital camera comprising an image capture element for capturing an original image, a memory for temporarily storing the original captured image as an image file, a first logic for generating edit description information used to edit the original captured image and for creating an edited image, where the edited image replaces the original captured image in the memory, and a second logic for generating undo edit description information used to reverse the edits and restore the original captured image.

The invention can also be conceptualized as a method for editing images on a digital camera, comprising capturing an original image, temporarily storing the original captured image as an image file, generating edit description information used to edit the original captured image, creating an edited image, where the edited image replaces the original captured image, and generating undo edit description information for reversing the edits and restoring the original captured image.

Related systems, methods of operation and computer readable media are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention, as defined in the claims, can be better understood with reference to the following drawings. The components within the drawings are not necessarily to scale relative to each other, emphasis instead being placed upon clearly illustrating the principles of the present invention.

FIG. 1 is a schematic view illustrating an exemplary digital camera in which an embodiment of the system and method for on-camera editing of digital images resides.

FIG. 2 is a schematic diagram illustrating an exemplary file structure representing the edited image of FIG. 1.

FIG. 3 is a graphical illustration showing an example of the operation of one embodiment of the edit logic of FIG. 1

FIG. 4 is a graphical illustration illustrating the operation of the embodiment of the invention described above with respect to FIG. 3.

FIGS. 5A and 5B collectively illustrate an alternative embodiment of the edit logic of FIG. 1.

FIG. 6 is a flow chart describing the operation of an embodiment of the edit logic of FIG. 1.

FIG. 7 is a flow chart describing the operation of an alternative embodiment of the edit logic of FIG. 1.

### DETAILED DESCRIPTION OF THE INVENTION

The invention described below is applicable to any digital camera that includes on-camera edit capability. The system and method for on-camera editing of digital images can be implemented in hardware, software, firmware, or a combination thereof. In the preferred embodiment(s), the invention is implemented using firmware that is executed by an application specific integrated circuit (ASIC). In an alternative implementation, the invention may be implemented using a combination of hardware and software that is stored in a memory and that is executed by a suitable instruction execution system. The hardware portion of the invention can be implemented with any or a combination of the following technologies, which are all well known in the art: a discrete logic circuit(s) having logic gates for implementing logic functions upon data signals, an application-specific integrated circuit (ASIC) having appropriate combinational logic gates, a programmable gate array(s) (PGA), a field-programmable gate array (FPGA), etc. The software portion of the invention can be stored in one or more memory elements and executed by a suitable general purpose or application specific processor.

The program for on-camera editing of digital images, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

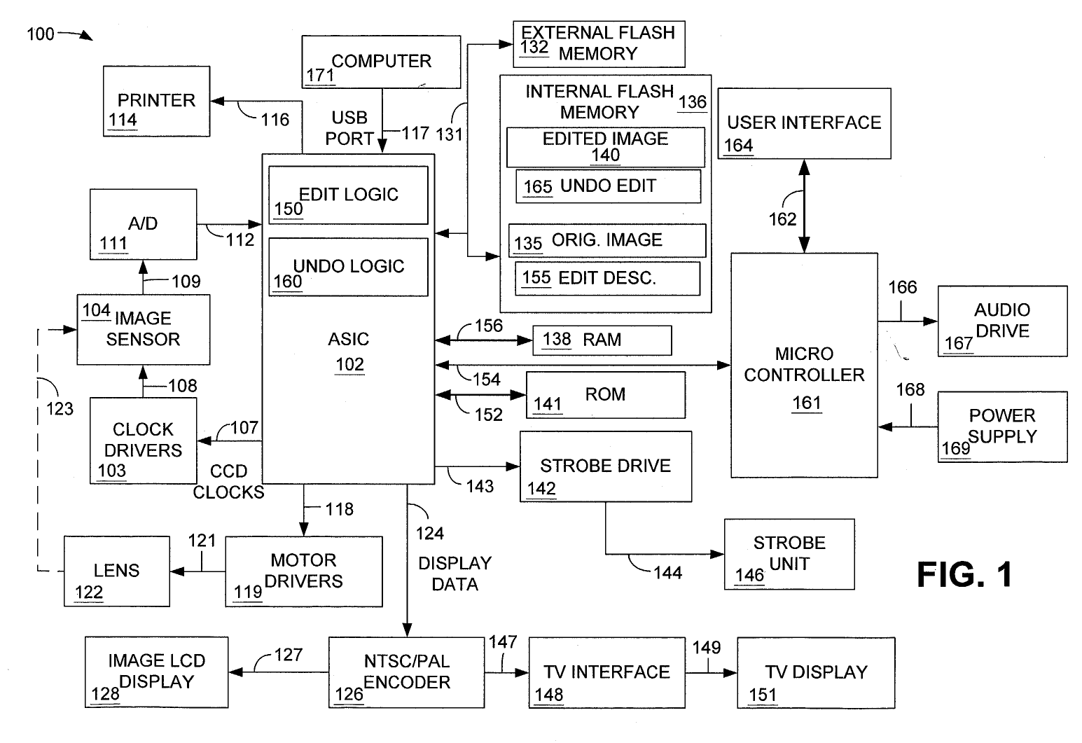

FIG. 1 is a block diagram illustrating a digital camera 100 constructed in accordance with an embodiment of the invention. In the implementation to be described below, the digital camera 100 includes an application specific integrated circuit (ASIC) 102 that executes the edit logic 150, which enables on-camera editing of digital images. In an alternative embodiment, the edit logic may be implemented in software, which can be stored in a memory and executed by a suitable processor. For example, the invention can be embodied in software that is stored in the internal flash memory (to be described below) and executed by a suitable microprocessor.

The ASIC 102 controls the function of various aspects of the digital camera 100. The ASIC 102 couples to a printer 114 via, for example, an infrared (IR) connection 116 and also includes a universal serial bus (USB) port 117, for connection to other processing devices, such as a personal computer 171. The ASIC 102 couples to a clock driver element 103 via connection 107. The clock driver element 103 couples via connection 108 to an image sensor 104. The image sensor 104 may be a charge coupled device (CCD) or a complementary metal oxide semiconductor (CMOS) sensor that is capable of detecting light from a lens 122 and converting the captured light into an electrical signal. The image sensor 104 captures an image of a subject (not shown) and sends an electronic representation of this image via connection 109 to an analog-to-digital converter 111. The analog-to-digital converter 111 converts the analog signal received from the image sensor 104 into a digital signal and provides this digital signal as image data via connection 112 to the ASIC 102 for image processing.

The ASIC 102 couples via connection 118 to one or more motor drivers 119. The motor drivers 119 control the operation of various parameters of the lens 122 via connection 121. For example, zoom and focus operations can be controlled by the motor drivers 119. The connection 123 between the lens 122 and the image sensor 104 is shown as a dotted line to illustrate the operation of the lens 122 focusing on a subject and communicating that information to the image sensor 104, which captures the image provided by the lens 122.

The ASIC 102 also sends display data via connection 124 to a national television system committee (NTSC)/phase alternate line (PAL) encoder 126. The encoder 126 converts the display data from the ASIC 102 into a signal that can be shown on image display 128 via connection 127. The encoder 126 also converts the output of the ASIC 102 on connection 124 to information that can be supplied to a television interface 148 via connection 147. The image display 128, which can be, for example a liquid crystal display (LCD) or other display, displays the captured image to the user of a digital camera 100, and is typically the display located on the digital camera 100. The TV interface 148 is typically one or more connections and/or interfaces that allow the output of the ASIC 102 to be displayed on a conventional television 151 via connection 149.

The ASIC 102 also supplies a strobe drive signal via connection 143 to the strobe drive element 142. The strobe drive element 142 activates a strobe unit 146 via connection 144 when it is determined that flash photography is either necessary or desired.

The ASIC 102 couples to a microcontroller 161 via connection 154. The microcontroller 161 can be a specific or a general purpose microprocessor that controls the various operating aspects and parameters of the digital camera 100. For example, the microcontroller 161 is coupled to a user interface 164 via connection 162. The user interface 164 may include, for example but not limited to, a keypad, one or more buttons, a mouse or pointing device, a shutter release, and any other buttons or switches that allow the user of the digital camera 100 to input commands. The microcontroller 161 also couples via connection 166 to an audio drive 167. The audio drive provides audible signals to the user of the digital camera 100. The microcontroller 161 also couples via connection 168 to a power supply 169. The power supply 169 may be, for example but not limited to, one or more batteries, an AC adapter, or any other type of power supply for powering the digital camera 100.

The ASIC 102 also couples to one or more memory elements, to be described below with particular reference to the type of memory to which the ASIC 102 is coupled over various connections. It should be noted that while specific types of memory are denoted below, the digital camera 100 may employ various other types of memory not specifically described herein. For example, the various memory elements may comprise volatile, and/or non-volatile memory, such as, for example but not limited to, random access memory (RAM), read-only memory (ROM), and flash memory. Furthermore, the memory elements may be either internal to the digital camera 100 or may be removable memory media, and may also comprise memory distributed over various elements within the digital camera 100. All such memory types are contemplated to be within the scope of the invention.

There are two basic digital camera architectures. A first camera architecture executes all program instructions directly from a ROM or flash memory. A second camera architecture includes a small “boot ROM” that copies program instructions from internal flash memory to RAM at boot-up, and thereafter execute instructions strictly from RAM. Both camera architectures can be used in conjunction with the invention.

The ASIC 102 couples to ROM 141 via connection 152. The ROM 141 houses the various software and firmware elements and components (not shown) that allow the digital camera 100 to perform its various functions. The ASIC 102 also couples to RAM 138 via connection 156. The RAM 138 generally provides temporary storage for the images captured by the image sensor 104.

The ASIC 102 also couples via connection 131 to an external flash memory 132 and an internal flash memory 136. As will be described in further detail below, the internal flash memory 136 provides storage for an original captured image file 135, an edited image file 140, an edit description 155 and for an undo edit description 165. However, while described as stored in the internal flash memory 136, the original captured image file 135, the edited image file 140, the edit description 155 and the undo edit description 165 may also be stored in the external flash memory 132.

The edit description 155 and the undo edit description 165 may each be stored as a separate file or as part of the edited image file 140. In one embodiment of the invention, the original image file 135 and the edit description 155 are stored in the internal flash memory 136. In this embodiment, an edited image will not be displayed unless the digital camera 100, or other viewing device such as a personal computer, can interpret the edit commands contained in the edit description 155 and generate an edited image 140.

In a second embodiment, the original image file 135 is edited using the information in the edit description 155 to generate the edited image file 140. The undo edit description 165 contains information generated using the information in the edit description 155, and is used to undo the edits. The undo edit description 165 and the edited image file 140 are stored in the internal flash memory 136 or the external flash memory 132, either in the same file or as separate files. In this embodiment, the edited image file 140 is available to a user of the digital camera 100, or other viewing device such as a personal computer, but the edits could be “undone,” by invoking the undo edit description 165 if the user desired to view the original image 135.

If the edited image file 140 is transferred to a device other than one capable of interpreting the undo edit description 165, the device to which the edited image file 140 is transferred merely ignores the undo edit description 165 and displays the image associated with the edited image file 140. In this manner, the undo logic 160 in the ASIC 102 allows a user to “undo” the edits on the digital camera 100 (or on another computing device that contains the undo logic 160), but still view the edited image with any reader capable of reading the edited image file.

The following discussion will focus on the second embodiment. The undo edit description 165 can be a portion of the edited image file 140 that includes the information used to restore the original captured image 135 from the edited image file 140. In accordance with an embodiment of the invention, when a user decides to edit the original captured image 135, the edit commands are entered via the user interface 164 and stored in the internal flash memory 136 as an undo edit description 165.

The undo edit description 165 is generated from the edit description 155 by the undo logic 160, and is contained within the edited image file 140 so that the information provided by the undo description 165 will always remain with the edited image file 140. When the undo edit description 165 is applied to the edited image file 140, the original captured image file 135 is restored. As the user views the edited image on the image display 128, the user views the edited image file 140, which is the original image file 135 as modified by the edit description 155. In this manner, the user is able to edit and view an image, while only the edited image file 140 and the undo edit description 165 are stored in the internal flash memory 136.

The undo edit description 165 is created by the undo logic 160 using information in the edit description 155 and includes the information that describes the original image file 135. The file that contains the original image file 135 plus the edit description 155, or the file that contains the edited image file 140 plus the undo edit description 165 are similar in size, which is only slightly larger than the original image file. In this manner, on-camera editing of an original captured image 135 is possible without requiring extensive memory capacity.

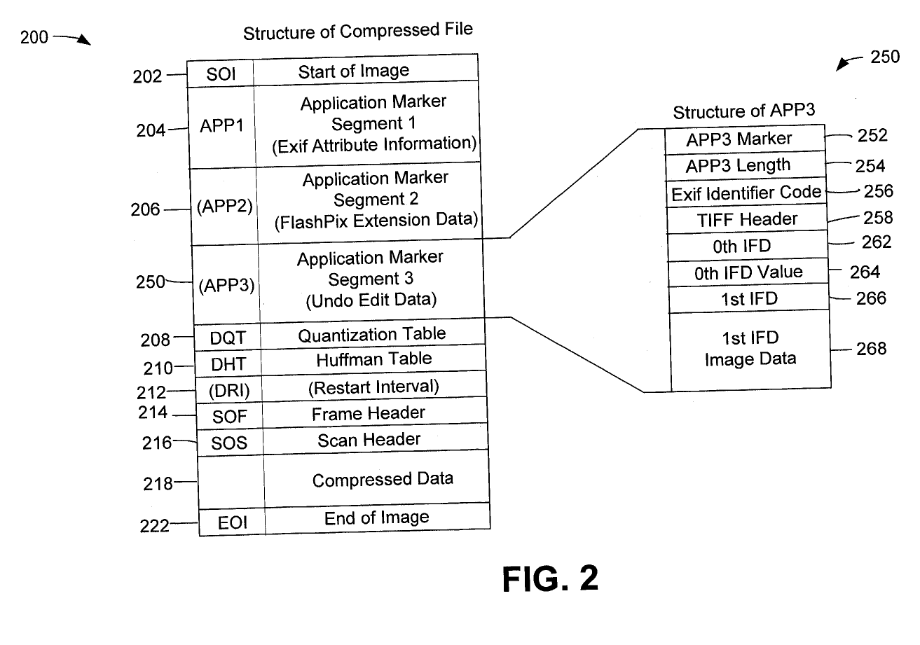

FIG. 2 is a schematic diagram illustrating an exemplary file structure 200 representing the edited image file 140 of FIG. 1. The file structure 200 is referred to as an Exif file, which is a standard digital still camera (DSC) file type as known to those having ordinary skill in the art of JPEG (joint photographic experts group) compression. The file structure 200 contains standard JPEG information, thumbnail information and camera setting information. The file structure 200 essentially includes the edited image file 140 and the undo edit description 165 of FIG. 1. The file structure 200 includes a start of image (SOI) frame 202, a first application marker (APP1) frame 204, a second application marker (APP2) frame 206, and a third application marker (APP3) frame 250.

The file structure 200 also includes a quantization table (DQT) frame 208, a Huffman table (DHT) frame 210, a restart interval (DRI) frame 212, a frame header (SOF) frame 214, a scan header (SOS) frame 216, the compressed data 218 (the image information), and an end of image (EOI) frame 222. The first application marker frame 204 and the second application marker frame 206, together with the compressed data 218, describe the edited image file 140 described above with respect to FIG. 1. The data is compressed to more efficiently use available memory capacity. The quantization table frame 208, the Huffman table frame 210, the restart interval frame 212, the frame header frame 214, the scan header frame 216 and the end of image frame 222, are all standard JPEG features and are known to those having ordinary skill in the art.

In accordance with an aspect of the invention, the file structure 200 includes the third application marker 250. The third application marker 250 includes attribute information that is stored as a TIFF (tagged image file format) file that includes the undo edit description 165 of FIG. 1. In this manner, the information contained in the undo edit description 165 (the third application marker 250 of FIG. 2) includes the information that is used to recover the original captured image file 135 of FIG. 1 from the edited image file 140 of FIG. 1.

The structure of the third application marker 250 is as follows. The third application marker 250 includes an “APP3” marker 252, an “APP3” length field 254, and an “Exif” identifier code 256. The third application marker 250 further includes a TIFF header 258, and a maximum of 2 image file directory (IFD) fields. The 0^{th} IFD field 262 records attribute information regarding the location of edits in the original image 135 of FIG. 1, and includes pointers to locations of data that will undo the edit commands. The 0^{th} IFD value field 264 includes the edit description information. The 1^{st} IFD field 266 records attribute information regarding the undo edit description 165, and includes pointers to locations of the undo edit image data. The 1^{st} IFD image data field 268 includes the undo edit image data.

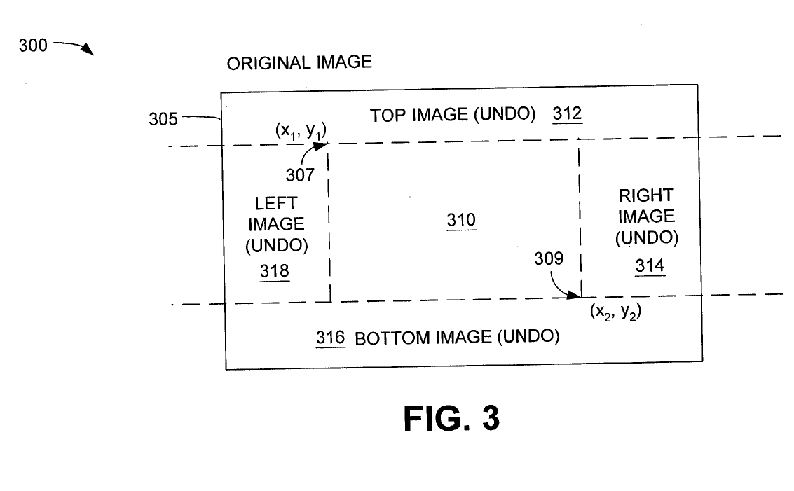

FIG. 3 is a graphical illustration 300 showing an example of the operation of one embodiment of the edit logic 150 of FIG. 1. In FIG. 3 an original image 305 is edited by identifying two pairs of X, Y coordinate points that define a rectangle occupying a portion of the original image 305. For example, the (x₁, y₁) coordinate point 307 and the (x₂, y₂) coordinate point 309 define two points in the original image 305 that a user has identified to define as “cropping” points that describe a rectangle containing the edited image 310 occupying a portion of the original image 305. When a user edits the original image 305 the result is the edited (cropped) image 310.

The user engages controls (not shown) on the user interface 164 (FIG. 1) while viewing the original image 305 on the image display 128 (FIG. 1) to decide which portion, or portions, of the original image 305 will be edited. In this example, four portions of the original image 305 are discarded. The top image 312, the right image 314, the bottom image 316 and the left image 318 are no longer a part of the edited image 310. However, in accordance with this aspect of the invention, when the original image 305 is edited to result in the edited image 310, the edited image 310 is stored in the internal flash memory 136 of FIG. 1, using the file structure 200 described above with respect to FIG. 2. Therefore, the edited image 310 is stored along with the undo edit description 165 that, when invoked, defines the original image 305.

However, because the undo edit description commands are stored along with the edited image, the undo logic 160, allows a user to “undo” the edits (the undo description information 250 of FIG. 2) thereby preserving the original captured image 305. For cropping removal, the location data are the (x₁, y₁) coordinate point 307 and the (x₂, y₂) coordinate point 309 on the original image 305. These points define the edited image 310 and also define the four image data regions, 312, 314, 316 and 318 that are edited from the original image 305. These four image data regions contain the top, right, bottom and left, respectively, image data that was removed from the original image 305 during the edit process.

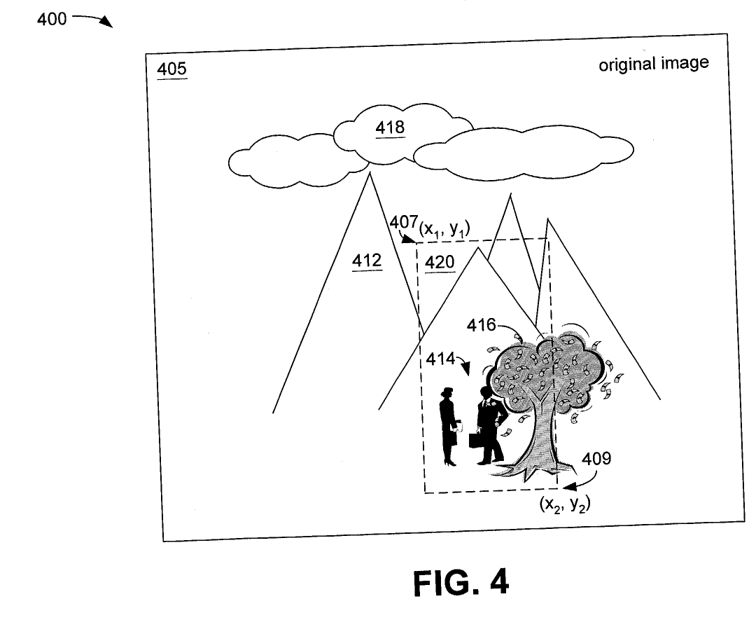

FIG. 4 is a graphical illustration 400 illustrating the operation of the embodiment of the invention described above with respect to FIG. 3. In FIG. 4, the original image 405 includes representations of individuals 414, a tree 416, mountains 412, and clouds 418. However, if the user desires to zoom in, or crop out certain portions of the original image 405, the user can engage the user interface 164 (FIG. 1) to perform on-camera edits to the original image 405. While viewing the original image 405 on the image display 128 (FIG. 1) the user may, for example, “zoom in” to the region 420. By entering edit commands via the user interface 164 (FIG. 1) the user defines the (x₁, y₁) location 407 and the (x₂, y₂) location 409 that define the region 420 as the desired edited region. The edit logic 150 stores the x and y coordinates as part of the undo edit description information 165, thereby allowing the user to edit the original image 405 on the digital camera 100.

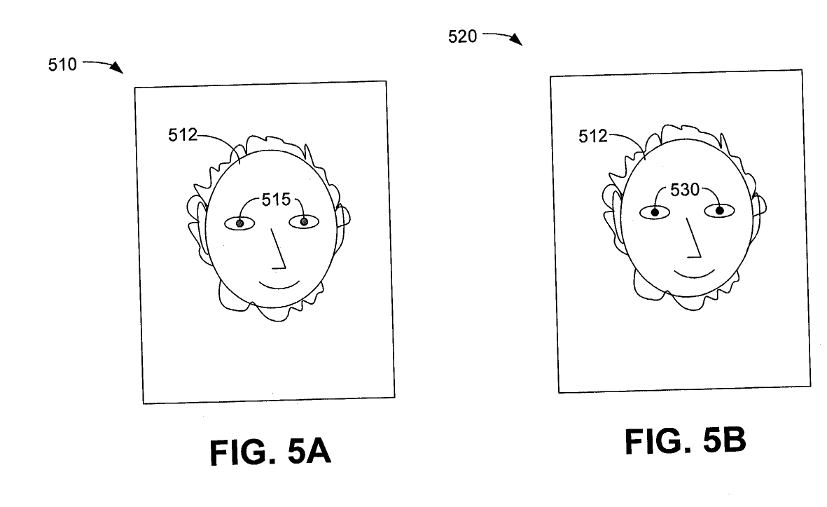

FIGS. 5A and 5B collectively illustrate an alternative embodiment of the edit logic 150 of FIG. 1. In FIG. 5A an image 510 includes a portrait of an individual 512.

However, as is common with flash photography, the portrait of the individual 512 includes a condition known as “red-eye.” Although not shown in FIG. 5A, the eyes 515 of the individual 512 may appear red in the photographic image due to the reflection of blood vessels on the back of the individual's eyes during flash photography. The edit logic 150 of the invention can be used to replace the small intense red areas 515 of the image in FIG. 5A with a dark color.

As described above with respect to FIG. 2, the location data that corresponds to the red image of the eyes 515 results in a series of x, y coordinates which define the area to be modified, along with a pointer to the original bitmap for that region. This information is stored in the file structure 200 of FIG. 2, thereby preserving the original image file information. The replacement of the red-eye condition is illustrated in FIG. 5B, where a dark color now fills the eyes 530 of the individual 512.

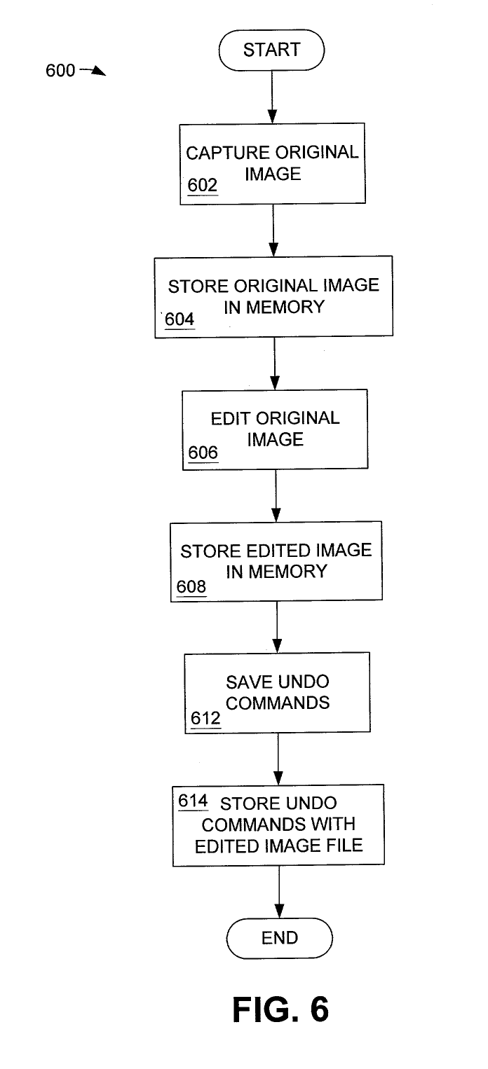

FIG. 6 is a flow chart 600 describing the operation of an embodiment of the edit logic 150 and undo logic 160 of FIG. 1. In block 602 an original image is captured using the digital camera 100. In block 604 the original captured image is stored as an original image 135 in the internal flash memory 136 (FIG. 1).

In block 606, a user engages controls on the user interface 164 (FIG. 1), while viewing the original image 135 on the image display 128, to edit the original image as described above with respect to FIGS. 3, 4, and 5. In block 608, when the user completes the editing process, the edited image file 140 is stored in the internal flash memory 136. In block 612, the commands that the user entered to create the edited image file 140, and some or all portions of the original image 135 are saved as the commands in the undo edit description 165 (FIG. 1).

In block 614, the undo edit description 165 is stored with the edited image file 140 in the internal flash memory 136 in accordance with the file structure 200 described above with respect to FIG. 2.

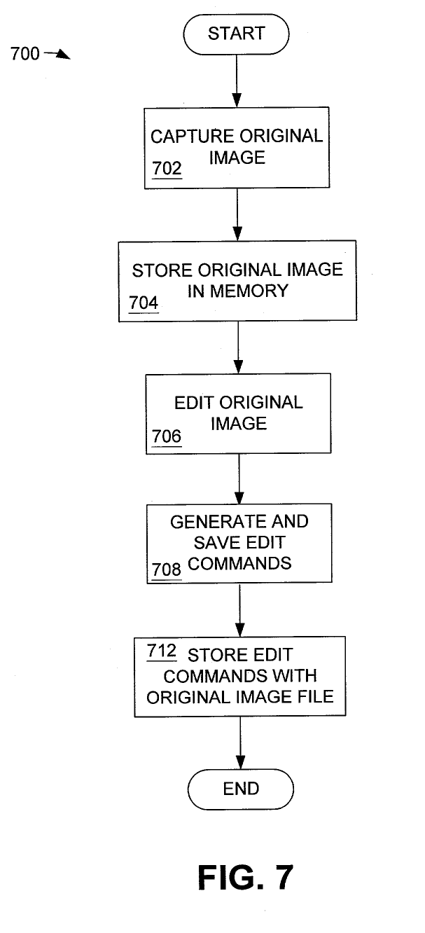

FIG. 7 is a flow chart 700 describing the operation of an alternative embodiment of the edit logic 150 of FIG. 1. In block 702 an original image is captured using the digital camera 100. In block 704 the original captured image is stored as an original image 135 in the internal flash memory 136 (FIG. 1).

In block 706, a user engages controls on the user interface 164 (FIG. 1), while viewing the original image 135 on the image display 128, to edit the original image as described above with respect to FIGS. 3, 4, and 5. In block 708, the commands that the user entered to edit the original image file 135 are generated and saved as the commands in the edit description 155 (FIG. 1). In block 712, the edit description 155 and some or all portions of the original image 135 are saved in the memory 136.

It will be apparent to those skilled in the art that many modifications and variations may be made to the preferred embodiments of the present invention, as set forth above, without departing substantially from the principles of the present invention. For example, the system and method for on-camera editing of digital images can be used in any digital camera/computer environment to edit an image file and retain the ability to restore the original image, without requiring significant memory capacity. All such modifications and variations are intended to be included herein within the scope of the present invention, as defined in the claims that follow.

What is claimed is:

1. A system for editing images on a digital camera, comprising:
an image capture element for capturing an original image;
a memory for temporarily storing the original captured image as an image file;
a first logic for generating edit description information used to edit the original captured image and creating an edited image, where the edited image replaces the original captured image in the memory; and
a second logic for generating undo edit description information used to reverse the edits and restore the original captured image.

2. The system of claim 1, wherein the edited image and the undo edit description information are stored as separate files.

3. The system of claim 1, wherein the edited image and the undo edit description information are stored in the same file.

4. The system of claim 1, wherein the edited image is compressed.

5. The system of claim 1, wherein the undo edit description information is generated from the edit description information.

6. A method for editing images on a digital camera, comprising:
capturing an original image;
temporarily storing the original captured image as an image file;
generating edit description information used to edit the original captured image;
creating an edited image, where the edited image replaces the original captured image; and
generating undo edit description information for reversing the edits and restoring the original captured image.

7. The method of claim 6, further comprising storing the edited image and the undo edit description information as separate files.

8. The method of claim 6, further comprising storing the edited image and the undo edit description information in the same file.

9. The method of claim 6, further comprising compressing the edited image.

10. The method of claim 6, further comprising generating the undo edit description information from the edit description information.

11. A system for editing images on a digital camera, comprising:
means for capturing an original image;
means for storing the original captured image as an image file;
means for editing the original captured image to develop an edited image, where the editing means generates edit description information;
means for replacing the original captured image with the edited image;
means for generating undo edit description information; and
means for restoring the original captured image from the edited image.

12. The system of claim 11, further comprising means for storing the edited image and the undo edit description information as separate files.

13. The system of claim 11, further comprising means for storing the edited image and the undo edit description information in the same file.

14. The system of claim 11, further comprising means for compressing the edited image.

15. The system of claim 11, further comprising means for generating the undo edit description information from the edit description information.

16. A system for editing images on a digital camera, comprising:
an image capture element for capturing an original image;
a memory for storing the original captured image as an image file;
a first logic for generating edit description information used to edit the original captured image, where the edit description information is stored as a separate file in the memory with the original captured image.

17. The system of claim 16, wherein the separate file containing the edit description information includes only the information used to create an edited image.

18. The system of claim 17, wherein the edited image is displayed on the digital camera.
